(19) United States
(12) Patent Application Publication
(10) Pub. No.: US 2010/0213279 A1
(43) Pub. Date: Aug. 26, 2010

(54) Automatic Fluid Dispenser For Shower

(76) Inventor: Raymond Frederick, Derry, NH (US)

Correspondence Address: JOSEPH E. FUNK, 82 CHASE RD, LONDONDERRY, NH, 03053, US

(21) Appl. No.: 12/359,295

(22) Filed: Feb. 22, 2009

(51) Int. Cl. B05B 7/26; B67D 5/38; B67D 5/08

(52) U.S. Cl. 239/310; 222/23; 222/52; 222/639

(57) ABSTRACT

A user programmable dispenser is disclosed for dispensing and mixing soap, shampoo or other liquids from a container to a mixer to be mixed with water flowing to a shower spray nozzle. A touch screen LCD display connected to a programmable controller is used by the user to first program the amount of time that the soap, shampoo or other liquids is to flow through a valve and be mixed with the water flowing from the shower spray nozzle, then is used to temporarily interrupt and recommence the flow of liquid, and is also used to display the amount of time remaining for the flow of the soap, shampoo or other liquids from the container of the time initially programmed by the user for the flow of liquid from the container to the mixer.

### FIELD OF THE INVENTION

The invention relates to dispensers for liquid soaps and shampoos and more particularly to an automatic dispenser of such liquids.

### DESCRIPTION OF THE PRIOR ART

The use of dispensers for liquid soaps and shampoos is known in the prior art. More specifically, dispensers for liquid soaps and shampoos heretofore devised and utilized are known to consist basically of familiar, expected and obvious structural configurations.

Known prior art includes U.S. Pat. No. 3,198,437 by J. C. Faglie and entitled Shower Bath Dispenser; U.S. Pat. No. 3,720,352 by R. L. Kozlowski and entitled Device For Selectively Dispensing Liquids; U.S. Pat. No. 3,409,230 by H. H. EElkema and entitled Dispenser For Shower Heads; U.S. Pat. No. 3,917,172 by H. M. O'Hare and entitled Fluid Mixing and Dispensing Apparatus; U.S. Pat. No. 4,085,867 by Heller and entitled Dispensing Containers and Holder; U.S. Pat. No. 3,990,611 by Sojka and entitled Plural Metering Dispensers With Wall Securing Rack; U.S. Pat. No. Des. 333,063 by Podesta Burke and entitled Shower Dispenser For Shampoo; U.S. Pat. No. 4,131,232 by A. D. Pollinz1 and entitled Automatic shower dispenser; U.S. Pat. No. 4,218,013 by C. A. Davison and entitled Shower head fluid dispenser; U.S. Pat. No. 4,956,883 by D. Lane and entitled Shower Fixture; U.S. Pat. No. 6,041,971 by E. Pineda and entitled Automatic shower hair product dispenser; U.S. Pat. No. 6,550,695 by C. Trent and entitled Shower Head Including Integral Containers for Dispensing Products; U.S. Pat. No. 7,201,331 by S. Bertrand and entitled Shower Device; U.S. Pat. No. 4,165,824 by Sud and entitled Self Cleaning Shampoo Dispenser; U.S. Pat. No. 5,044,522 by Roig and entitled Shampoo Dispenser; U.S. Pat. No. 4,826,048 by Skorka et al. and entitled Dispenser for Manually Discharging Plural Media; and U.S. Pat. No. 3,997,080 by Langstroth and entitled Pressurized Liquid Mixer and Dispenser System.

All of the above listed prior art soap and shampoo dispensers either require that a user must be actively pressing a button in order to have soap or shampoo dispensed or, alternatively, the soap or shampoo is being dispensed all the time which is wasteful. In the former the user cannot push a dispensing button and, at the same time, be washing themselves with a wash cloth. In the latter, soap or shampoo is being dispensed when the user does not want it to be dispensed, such as when they want to rinse. The user must take an active measure to stop the flow of soap or shampoo before they can rinse.

### SUMMARY OF THE INVENTION

The foregoing problems of the prior art are solved by the present invention. A user programmable, battery powered, automated dispensers for liquid soaps and shampoos is disclosed. A user of the novel dispenser may initially program how long a liquid such as soap or shampoo is to be dispensed, and may temporarily pause or terminate dispensing the liquid before the programmed period has expired.

To install the novel liquid soap or shampoo dispenser in a shower the shower head is first removed and a mixer body is screwed onto the threads of the shower water feed pipe protruding from the wall. A main body of the dispenser which holds containers of soap or shampoo and the control electronics is hung from shower water feed pipe and may be slid thereon before the mixer body is screwed onto the threads of the shower water feed pipe.

The mixer body has an externally threaded pipe protruding from it to which the shower head is attached. A short piece of flexible tubing connects the dispenser main body to the mixer body. Soap or shampoo dispensed by the dispenser main body passes through the tubing and into the mixer body where it is mixed with water passing through mixer body as it goes to the shower head.

The dispenser main body has a recess into which an inverted container of soap or shampoo is inserted. A cap on the container preferably has a rubber or other flexible membrane that is penetrated by a hollow needle like member when the container is inserted into the recess of the main body. Soap, shampoo, or some other liquid in the container exits the container through the hollow needle under the force of gravity. However, the liquid cannot flow anywhere except under control of circuitry contained inside the main body. The control circuitry enables a pump and valve to send the soap, shampoo, or other liquid through the tubing to the mixer body.

Mounted essentially flush with the outer surface of the dispenser main body is an LCD display equipped with touch screen capability. The LCD display is mounted in the wall of the dispenser main body in a watertight manner. The user of the novel programmable, automated dispenser uses the touch screen capability of the LCD display to program the dispenser to dispense a timed amount of the soap or shampoo and then to start the operation. The user can start the timed dispensing of soap or shampoo at any time while taking a shower, and can pause and restart the process at any time while taking a shower. Thus, the user does not experience the previously described shortcomings of prior art soap and shampoo dispensers.

The touch LCD screen provides basic control of the novel dispenser after it is turned on and to accomplish this there are a number of control buttons displayed on the LCD screen. There is a Pause button to commence, temporarily pause, and terminate dispensing soap. There is a Soap Run Time button display and Plus and Minus buttons utilized by the user of the dispenser to increase and decrease the soap run time to meet personal tastes. To start the operation of the dispenser a separate Power button mounted adjacent to the LCD display is touched. After being powered on the Soap Run Time button display is touched to select the function and the user then uses the Plus and Minus buttons to increment or decrement the total number of seconds that soap or shampoo will be dispensed. There is a Time Remaining display which indicates the remaining number of seconds that soap or shampoo will be dispensed after dispensing has been commenced.

Once a user turns on and programs the dispenser they may start taking a shower. When they desire to commence dispensing soap or shampoo they touch the Pause button, which is initially in a pause state as indicated by the word “ON” being displayed in the on-screen button, to exit the pause state and start the flow of soap or shampoo. While shampoo is being dispensed the word “OFF” is displayed in the on-screen Pause button. A small motor driven pump pumps the soap or shampoo through the tubing to the mixer body where it is mixed with water of a desired temperature flowing through the mixer body to the shower head. As the soap or shampoo is dispensed into the water flow a clock timer counts down from the user programmed number of seconds that the liquid will be dispensed. In this manner the user does not have to take any action to terminate the flow of the soap or shampoo. When the programmed time has run out the flow of soap or shampoo is terminated.

However, the user still has control of dispensing of the soap or shampoo during operation. If they decide at any time to pause the flow of soap or shampoo they touch the Pause button. The word displayed therein changes from “OFF” to “ON”. Thereafter, they may again touch the Pause button to recommence the flow of the soap or shampoo. The word displayed therein changes from “ON” to “OFF”. The user also has the option of terminating the dispensing operation by touching the separate Power button to shut the dispenser off. All user settings are then erased.

Thus, the user of the novel dispenser has much greater flexibility in dispensing soap or shampoo than provided by prior art dispensers.

There has been outlined above, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. For example, an alternative embodiment of the invention having two or more liquid containers may be provided. Soap and shampoo containers may be mounted in the main body and each may be programmed as previously described. It is important, therefore, that the claims be regarded as including such equivalent constructions insofar as they do not depart from the spirit and scope of the present invention.

Further, the purpose of the Abstract of the invention is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new automatic shower soap and shampoo dispenser apparatus which has many of the advantages of the dispensers for liquid soaps and shampoos mentioned heretofore and many novel features that result in a new automatic shower soap and shampoo dispenser which is not anticipated, rendered obvious, suggested, or even implied by any of the prior art dispensers for liquid soaps and shampoos, either alone or in any combination thereof.

It is another object of the present invention to provide a new automatic shower soap and shampoo product dispenser which may be easily and efficiently manufactured and marketed.

It is a further object of the present invention to provide a new automatic shower soap and shampoo dispenser which is of a durable and reliable construction.

Still yet another object of the present invention is to provide a new automatic shower soap and shampoo dispenser which provides some of the advantages of the prior art, while simultaneously overcoming some of the disadvantages normally associated therewith.

Further, another object of the present invention is to provide a new automatic shower soap and shampoo dispenser that dispenses metered amounts of soap and/or shampoo there from.

### DESCRIPTION OF THE DRAWING

The invention will be better upon reading the following Detailed Description in conjunction with the drawing in which:

FIG. 1 shows a typical prior art shower head extending from a wall inside a shower enclosure;

FIG. 2 shows a general representation of the automated dispenser apparatus of the present invention attached to a shower head;

FIG. 3 shows the dispensing end of a disposable container in which is contained a liquid to be dispensed such as soap and shampoo;

FIG. 4 shows a container with soap or shampoo therein being inserted into the novel, automated, programmable dispenser apparatus of the present invention;

FIG. 5 shows a container with soap or shampoo therein fully inserted into the novel, automated dispenser to be dispensed as programmed by a user of the novel, automated dispenser apparatus;

FIG. 6 shows a side cutaway view of a mixer in which soap or shampoo is mixed with water flowing there through to a shower head;

FIG. 7 shows a block diagram of the circuitry and hardware of the automated soap or shampoo dispenser;

FIG. 8 shows a touch screen LED display that is used to program the operation of the novel dispenser before the dispenser is powered on; and

FIG. 9 shows a touch screen LED display that is used to program the dispensing of soap or shampoo after the dispenser is powered on and showing settings determined by the user of the dispenser.

### DETAILED DESCRIPTION

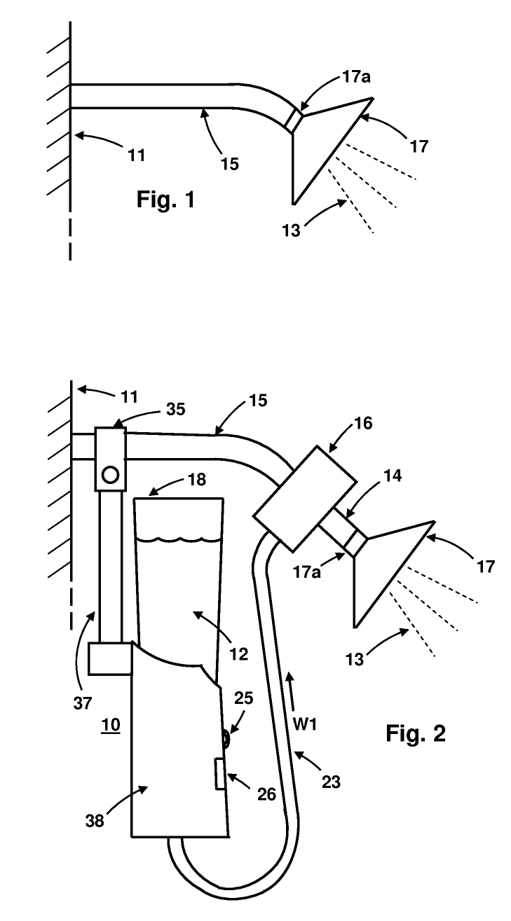

In FIG. 1 is shown a prior art shower head 17. Head 17 has an internally threaded neck 17a that is screwed onto external threads of a water feed pipe 15 that protrudes from the wall 11 of a shower stall or tub in a manner well known in the art. When external hot and cold water and water direction flow controls, not shown, are actuated by a user, water 13 of a desired temperature sprays from shower head 17.

In FIG. 2 is shown the novel automated soap or shampoo dispenser 10 mounted to a water feed pipe 15. The dispenser 10 comprises a mixer body 16 that is quickly and easily mounted inline between the water feed pipe 15 and the shower head 17. This is done by first unscrewing shower head 17 from the outer end of water feed pipe 15. An internally threaded end of mixer 16 is then screwed onto the outer end of water feed pipe 15. The other end of mixer 16 is also internally threaded and a first end of a short piece of pipe 14 is screwed therein. The shower head 17 is then screwed onto a second or outer end of the short piece of pipe 14. Plumbers tape or putty (not shown) is preferably placed on the threaded ends of pipes 14 and 15 that are screwed into the two ends of mixer 16 to prevent leaks. Similarly, plumbers tape or putty (not shown) is preferably placed on the threaded end of pipe 14 that is screwed into threaded neck 17a of shower head 17 to prevent leaks.

There is also a dispenser main body or base 38 that is suspended from feed pipe 15 by a vertical support 37 and a fastener 35 as shown. Fastener 35 has a screw that is used to clamp vertical support 37 firmly to water feed pipe 15. Preferably fastener 35 may be placed over water feed pipe 15 after shower head 17 is removed and before mixer 16 is screwed onto the outer end of water feed pipe 15, but fastener 35 may be attached around water feed pipe 15 after mixer 16 is screwed onto the outer end of water feed pipe 15.

A short piece of tubing 23 connects base 38 to mixer 16 as shown. During the programmed operation of dispenser 10 a metered amount of soap or shampoo 12 is pumped through tubing 23 in the direction of arrow WI into mixer 16. The soap or shampoo 12 mixes with water flowing from water feed pipe 15, through mixer 16 and pipe 14 and exits shower head 17 as spray 13.

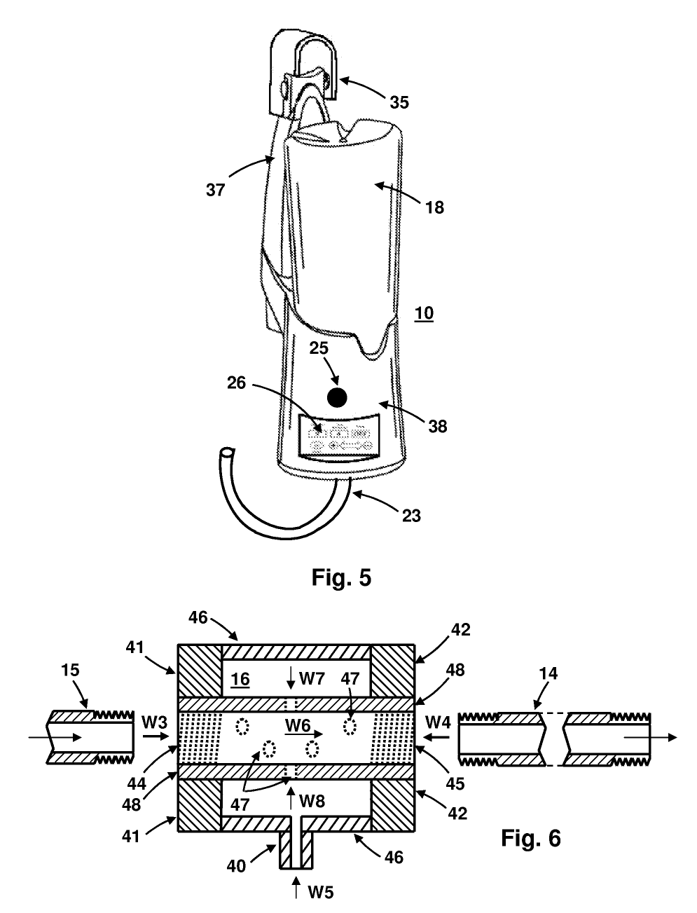

A container 18 containing soap or shampoo 12 is inserted into base 38 in an inverted manner as shown. Container 18 is also shown in and described with reference to FIGS. 4 and 5. Container 18 is preferably transparent or at least translucent so that the quantity of soap or shampoo 12 therein is visible as shown in FIG. 2.

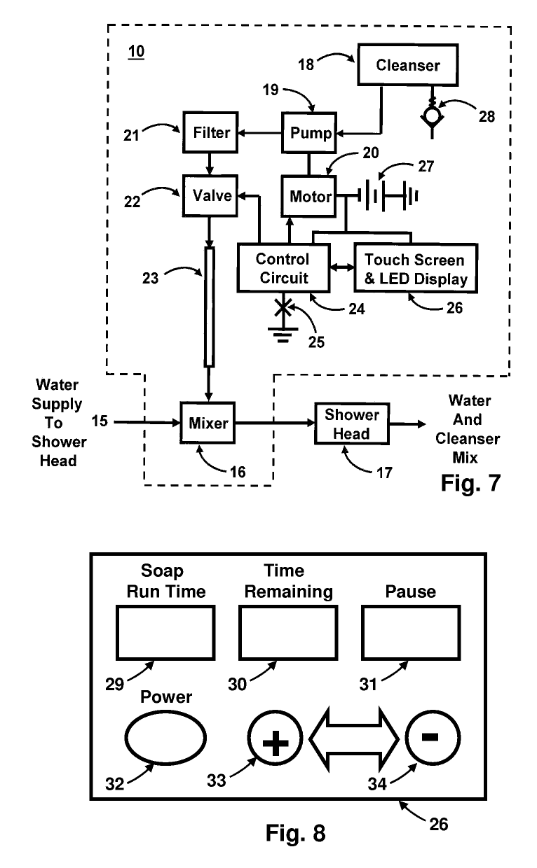

The operation of the automated, programmable dispenser 10 is controlled by a user using an interactive visual display on LED touch screen display 26 mounted in the surface of base 38 in a water tight manner. Display 26 is shown in FIG. 4 and is described in more detail with reference to FIG. 7.

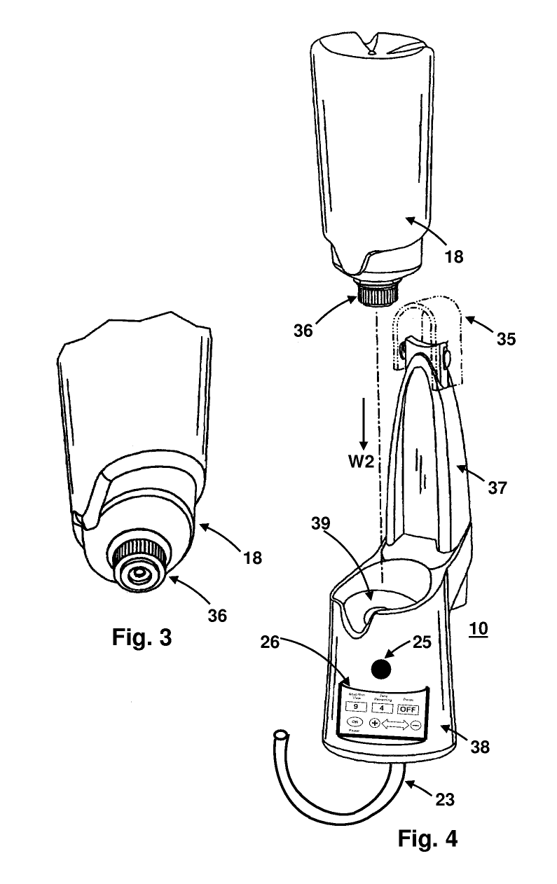

When a soap or shampoo container 18 is empty, base 38 is swung to the side, the empty container 18 is removed and a filled container 18 is inserted into base 38. Base 38 is re-positioned beneath water feed pipe 15 and dispenser 10 is again ready for use. Pre-filled containers may be purchased or, alternatively, the cap 36 (FIG. 3) sealing the container 18 may be removed and the bottle refilled and reused.

In FIG. 3 is shown the dispensing end of a disposable container 18 in which is contained the soap and shampoo 12. Sealing container 18 is a cap 36 which has a flexible membrane at its center that normally prevents soap and shampoo 12 from inadvertently flowing out of container 18. When container 18 is inserted into base 38 as shown in FIGS. 4 and 5 a hollow needle (not shown) inside recess 39 pierces the flexible membrane and the soap or shampoo inside container 18 may be pumped through the hollow needle and then through flexible tubing 23 to mixer 16. This is described in more detail with reference to FIGS. 6 and 7.

In FIG. 4 is shown an inverted container 18 with soap or shampoo 12 therein in the process being inserted into the novel, automated, programmable dispenser 10 of the present invention. Container 18 is moved in the direction of arrow W2. The shape of the neck area of container 18 matches the shape of recess 39 so that container 18 is held snugly in recess 39 as shown in FIG. 5.

In FIG. 4 the interactive visual display on LED touch screen display 26 is shown mounted in the surface of base 38 in a water tight manner. Display 26 is described in more detail with reference to FIG. 7. Details of vertical support 37 and fastener 35 are better seen in FIG. 4. Immediately above display 26 is a Power On-Off button 25 which is used to power on or power off the dispenser.

In FIG. 5 is shown a container 18 with soap or shampoo 12 therein fully inserted into the recess 39 in base 38 of the novel, automated dispenser 10.

In FIG. 6 is shown a side cutaway view of a mixer 16 in which soap or shampoo 12 is mixed with water flowing from a shower head 17 as spray 13 as generally shown in FIG. 2. Mixer 16 has a tubular side wall 46 with a left or input end piece 41 affixed to the left side of wall 46, and a right or output end piece 42 affixed to the right side of wall 46. Tubular side wall 46 has an input port 40 through which soap or shampoo 12 flows from flexible tubing 23 (FIG. 2) as indicated by arrow W5. Walls 41, 42 and 46 create a chamber into which the soap or shampoo 12 enters via input port 40.

Left or input end piece 41 has a hole through its center, and right or output end piece 42 has a hole through its center. Passing through these two holes and bonded thereto is a tubular piece 48 that has a plurality of holes 47 through its side wall. Representative holes 47 are shown in FIG. 6 but there may actually be fewer or more holes 47. One skilled in the art will choose the number of holes and their diameter along with the rate that soap or shampoo is pumped into the interior of mixer 16 to set the rate at which the soap or shampoo 12 is mixed with water passing through mixer 16 to shower head 17.

The inside wall of the left end of tubular piece 48 is threaded to receive the threaded right end of water feed pipe 15 as indicated by arrow W3. When mounting mixer 16 to the outer or right end of water feed pipe 15 it is mixer 16 that is actually turned onto the threads of pipe 15. The female and male threads are industry standard and mate perfectly for this purpose. Plumbers putty or tape is preferably placed on the threads of water feed pipe 15 before it is screwed into tubular piece 48 of mixer 16.

The inside wall of the right end of tubular piece 48 is also threaded to receive the threaded left end of connector pipe 14 as indicated by arrow W4. When mounting connector pipe 14 to the right end of tubular piece 48 it is pipe 14 that is actually turned into the threads of tubular piece 48. The female and male threads are industry standard and mate perfectly for this purpose. Plumbers putty or tape is preferably placed on the threads of connecter pipe 14 before it is screwed into the right end of tubular piece 48 of mixer 16.

Water flowing through water feed pipe 15 in the direction of arrow W3 passes through mixer 16 as indicated by arrow W6 and, as it exits mixer 16, flows through connector pipe 14 to shower head 17 and exits shower head 17 as spray 13 as shown in FIG. 2. While the water passes through mixer 16 soap or shampoo (not shown in FIG. 6) mixes with the water. This happens in the following manner. Briefly, with reference to FIG. 2, the user of the novel dispenser 10 uses LCD touch screen 26 to program the amount of time that soap or shampoo is to flow and at an appropriate time starts the operation by touching the on-screen Pause button and the word “ON” displayed therein changes to the word “OFF”. A pump inside base 38 is energized and pumps the soap or shampoo 12 inside container 18 through flexible tube 23 and through input port 40 into the aforementioned chamber created by walls 41, 42 and 46. The soap or shampoo 12, under pressure, flows through holes 47 and mixes with the water flowing through tubular piece 48. LCD touch screen 26 shown in FIG. 8 and the associated electronics shown in FIG. 7 are described in greater detail hereinafter with reference to FIGS. 7 and 8.

The description of FIGS. 7, 8 and 9 are presented together as it makes the most sense to do so. In FIG. 7 is shown a block diagram of the circuitry and hardware of the novel, automated dispenser 10. Dispenser 10 comprises container 18 having a cleanser therein which is preferably soap or shampoo 12. It also comprises base 38 which has mounted therein elements 19, 20, 21, 22 24, 25 and 26. Mixer 16 is mounted in series with the water feed pipe 15, as previously described, and soap or shampoo travel from base 38 to mixer 16 via tubing 23.

FIG. 8 shows the display on LCD touch screen 26 which is what is used to program dispenser 10 to dispense user selected amounts of soap or shampoo 12 from container 18. The display is blank because Power On-Off button 25 is not actuated.

Dispenser 10 is battery powered and batteries 27 are inserted under a cover (not shown) that has a watertight seal. A user of dispenser 10 initially powers on dispenser 10 by touching a Power On-Off button 25 on the side of base 38 adjacent to LCD touch screen 26. This button is seen in FIGS. 2, 4, 5 and 7. Button 25 closes a circuit with battery 27 and thereby energizes dispenser 10.

Before being powered on the LCD touch screen that is used to control operation of dispenser 10 looks like that shown in FIG. 8. No numbers are displayed in touch screen locations 29 and 30 which are respectively entitled “Soap Run Time” and “Time Remaining”. In addition, neither the word On or Off is displayed in touch screen location 31 entitled “Pause”. Further, the word On is not displayed in location 32 which is entitled “Power” and which indicates when dispenser is powered on using power switch 25. As an alternate way to indicate that dispenser 10 is powered On button 25 may have on integral LED which is lit when dispenser 10 is powered On.

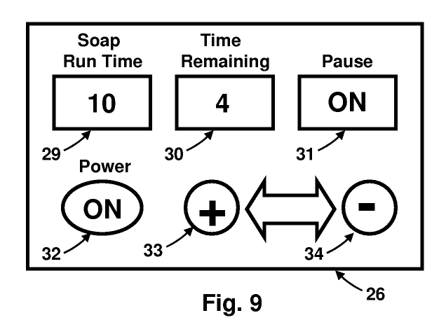

After dispenser 10 is powered on using Power switch 25, and dispenser 10 is in use dispensing soap or shampoo 12, touch screen 26 looks like that shown in FIG. 9. When dispenser 10 is first powered on control circuit 24 causes the word ON to appear in Power screen location 32 which gives the user of the dispenser a positive indication that dispenser 10 is powered on. In addition, control circuit 24 causes the word ON to appear in Pause screen location 31 indicating that soap or shampoo 12 is not presently being dispensed via mixer 16 into the shower water stream 13. The user must then provide a manual input indicating the number of seconds that soap or shampoo 12 is to be dispensed. The user does this by touching touch screen locations 33 and 34. To increase the number of seconds they touch the “+” button printed on location 33. The first time the “+” button 33 is touched the number “1” will be displayed in screen location 29 entitled “Soap Run Time”. Thereafter, each time the “+” button at screen location 33 is touched the number displayed at screen location 29 is incremented by one. In FIG. 9 the user has touched the “+” button ten times and the number “10” is displayed in location 29.

When dispensing of soap or shampoo 12 has not yet been started the number “10” is also displayed in location 30 indicating that ten seconds of dispensing remains. When the user starts dispensing soap or shampoo they have ten seconds of dispensing before dispensing ceases. In FIG. 9 the user has already been dispensing soap or shampoo for six seconds. Accordingly, the number “4” is displayed in screen location 30 indicating the user has only four seconds of soap or shampoo dispensing remaining.

Screen location 31 entitled “Pause” is a touch screen button in which control circuit 24 initially causes to be displayed the word “ON”. This indicates that no soap or shampoo 12 is being dispensed. After a user has programmed dispenser 10 and has commenced taking a shower, when they are ready to dispense soap or shampoo 12 they touch screen location button 31. This is sensed by control circuit 25 which first causes the word displayed in Pause screen location 31 to change to the word “OFF”. Soap or shampoo or cleanser 12 in container 18 must now be dispensed. Control circuit 24 energizes motor 20 which drives pump 19, and causes valve 22 to be opened. Soap or shampoo 12 in container 18 is pumped by pump 19 through a filter 21 and open valve 22. The soap or shampoo 12 then travels through flexible hose 23 to mixer 16. As previously described, water flowing through water feed pipe 15 flows through mixer 16 where it is mixed with the soap or shampoo 12 and the mixture then flows to shower head 17 where it is dispensed as spray 13. For each second that soap or shampoo is dispensed control circuit 24 causes the number that is displayed in “Time Remaining” screen location 30 to be decremented by one.

If, during showering, a user wishes to momentarily cease dispensing soap or shampoo 12 they touch “Pause” screen location 31. This is sensed by control circuit 24 which performs the following actions. The word “ON” is displayed in location 31, motor 20 is turned off, and valve 22 is closed. No soap or shampoo 12 is dispensed to mixer 16. During this pause time the number displayed in “Time Remaining” screen location 30 ceases to be decremented by control circuit 24. When the user wishes to continue dispensing soap or shampoo 12 they again touch screen location 31. This is sensed by control circuit 24 which then performs the following actions. The word “OFF” is displayed in location 31, motor 20 is turned on, and valve 22 is opened. Soap or shampoo 12 is again dispensed to mixer 16. The number displayed in screen location 30 commences to be decremented by one once every second.

In FIG. 9 is represented the situation where the user has paused the dispensing of soap or shampoo by touching screen location 31 and the word “ON” is displayed therein by control circuit 24. The number “4” displayed in “Time Remaining” screen location 30 remains the same as long as soap or shampoo dispensing is paused. This number indicates to the user that they have four seconds remaining, of their initially, manually programmed soap or shampoo dispensing period of 10 seconds.

In FIG. 7 there is shown a relief valve 28 connected to container 18 containing cleanser which will be in the form of either soap or shampoo. As cleanser is pumped from container 18 a vacuum is created therein. This vacuum must be relieved or pump 19 will quickly be unable to pump cleanser from container 18. Relief valve 28, which is well-known in the art, performs the function of relieving the vacuum created inside container 18 as cleanser is pumped therefrom.

In an alternative embodiment of the invention, which is not disclosed in detail herein, base 38 of dispenser 10 may be configured to hold two containers 12. One container could be soap while the other container could be shampoo. In a variation of this, one container could contain soap preferred by a first user of dispenser 10 and the second container could contain soap preferred by a second user of dispenser 10. In a logical expansion of this alternative embodiment more than two containers may be mounted in base 38. In any of these alternative embodiments of the invention the LCD display 26 and the logic performed in control circuit 24 would be expanded to permit the selection of different ones of two or more containers 18.

While what has been disclosed herein is a preferred embodiment of the invention it will be understood by those skilled in the art that numerous changes may be made without departing from the spirit and scope of the invention. For example, the water and soap or shampoo mixing may be performed by a different type of mixer. For another example, in lieu of LCD display 26 a plurality of buttons and LEDs may be used to control the operation of control circuit 24 and display the operational status of dispenser 10. In addition, in lieu of the indication on display 26 that power is on an LED may be mounted adjacent to Power button 25, or be an integral part thereof, that is lit to indicate that power is on to dispenser 10

What is claimed is:

1. A dispenser for dispensing liquids including soap and shampoo in a shower stall or tub area having a shower spray nozzle by mixing the liquids with water exiting the spray nozzle, the dispenser comprising:
a container holding a quantity of the liquid to be dispensed;
a valve for controlling the flow of the liquid to be dispensed from the container, the valve being in a first state blocking the flow of liquid from the container, and being in a second state permitting the flow of liquid from the container, the valve normally being in the first state;
programmable means for controlling the amount of time that the valve is in the second state to permit the flow of liquid from the container; and
mixing means receiving water flowing to the shower spray nozzle, the mixing means receiving the flow of liquid from the container when the valve is in the second state, the mixing means mixing the water and the last mentioned flow of liquid before it flows from the shower spray nozzle.

2. The dispenser for dispensing liquids of claim 1 further comprising control means coupled to the programmable control means for indicating the amount of time that the programmable control means places the valve in the second state to permit the flow of liquid from the container to the mixing means.

3. The dispenser for dispensing liquids of claim 2 wherein the control means is manually used by a user of the dispenser to indicate the amount of time that the valve is to be in its second state to permit the flow of liquid from the container to the mixing means.

4. The dispenser for dispensing liquids of claim 3 wherein the control means comprises a visual display with touch screen capability and is used by a user of the dispenser to indicate the amount of time that the valve is to be in its second state to permit the flow of liquid from the container to the mixing means.

5. The dispenser for dispensing liquids of claim 4 wherein the visual display displays the amount of time indicated by the user of the dispenser for the flow of liquid from the container to the mixing means.

6. The dispenser for dispensing liquids of claim 5 wherein, following commencement of flow of liquid from the container, the visual display also displays the amount of time remaining for the flow of liquid from the container of the time initially indicated by the user for the flow of liquid from the container to the mixing means.

7. The dispenser for dispensing liquids of claim 6 wherein the visual display with touch screen capability is used by the user to start the flow of liquid from the container to the mixing means after the display touch screen is used to indicate the amount of time that the valve is to be in its second state to permit the flow of liquid from the container to the mixing means.

8. The dispenser for dispensing liquids of claim 7 wherein the display touch screen is used by the user to temporarily interrupt and recommence the flow of liquid from the container to the mixing means.

9. The dispenser for dispensing liquids of claim 8 further comprising pump means energized and controlled by the programmable control means for pumping the liquid from the container to the mixing means when the valve is placed in its second state by the programmable control means.

10. A dispenser for dispensing liquids including soap and shampoo in a shower stall or tub area including a shower spray nozzle by mixing the liquids with water exiting the spray nozzle, the dispenser comprising:
a container holding a quantity of the liquid to be dispensed;
a valve for controlling the flow of the liquid to be dispensed from the container, the valve being in a first state blocking the flow of liquid from the container, and being in a second state permitting the flow of liquid from the container, the valve normally being in the first state;
means for controlling the amount of time that the valve is in the second state to permit the flow of liquid from the container to the shower spray nozzle; and
mixing means receiving water flowing to the shower spray nozzle, the mixing means being connected to the valve and receiving the flow of liquid from the container when the valve is placed in the second state by the controlling means, the mixing means mixing the water and the last mentioned flow of liquid before it flows from the shower spray nozzle.

11. The dispenser for dispensing liquids of claim 10 further comprising indicating means for manually indicating to the controlling means the amount of time that the liquid is to flow from the container to the mixing means.

12. The dispenser for dispensing liquids of claim 10 further comprising start means used by the user to indicate to the controlling means to start the flow of liquid from the container to the mixing means.

13. The dispenser for dispensing liquids of claim 12 wherein the start means is used by the user to temporarily interrupt and recommence the flow of liquid from the container to the mixing means.

14. The dispenser for dispensing liquids of claim 13 further comprising display means for displaying to the user of the dispenser the amount of time that the valve is to be in its second state to permit the flow of liquid from the container to the mixing means.

15. The dispenser for dispensing liquids of claim 14 wherein following commencement of flow of liquid from the container, the display means also displays the amount of time remaining for the flow of liquid from the container of the time initially indicated by the user for the flow of liquid from the container to the mixing means.

16. The dispenser for dispensing liquids of claim 15 further comprising pump means energized and controlled by the control means for pumping the liquid from the container to the mixing means when the valve is placed in its second state by the control means.
